(19) United States
(12) Patent Application Publication
(10) Pub. No.: US 2026/0110138 A1
(43) Pub. Date: Apr. 23, 2026

(54) LIGNIN-BASED RESINS FOR OIL-RESISTANCE PAPER PACKAGING

(71) Applicant: University of Tennessee Research Foundation, Knoxville, TN (US)

(72) Inventors: Shahaboddin Saedi, Knoxville, TN (US); Siqun Wang, Knoxville, TN (US)

(73) Assignee: University of Tennessee Research Foundation, Knoxville, TN (US)

(21) Appl. No.: 19/367,628

(22) Filed: Oct. 23, 2025

Related U.S. Application Data
(60) Provisional application No. 63/710,991, filed on Oct. 23, 2024.

(51) Int. Cl. D21H 19/10; C09D 197/00; D21H 21/16; D21H 27/10

(52) U.S. Cl. CPC D21H 19/10; C09D 197/005; D21H 21/16; D21H 27/10

(57) ABSTRACT

Resole resin compositions were made from a reaction of a lignin, an aldehyde, and a strong base, which is free of formaldehyde and free of per- and poly-fluoroalkyl substances. The aldehyde is one or more of a straight or branched chain dialdehyde, a phenolic aldehyde, and a furanic aldehyde. The resole resin is coated on a paper substrate to produce an oil resistant paper product suitable for food packaging, tableware, oil-resistant liners, and the like. Methods of making the resole resin composition and the paper products are also described herein.

### CROSS-REFERENCE TO RELATED APPLICATION

This application claims the benefit of U.S. Provisional application No. 63/710,991, filed Oct. 23, 2024, the entirety of which is incorporated herein by reference.

### GOVERNMENT LICENSE RIGHTS

This invention was made with government support under contract 2022-68016-36896 awarded by the United States Department of Agriculture. The government has certain rights in the invention.

### TECHNICAL FIELD

The disclosed invention relates to the field of lignin resin coated, oil-resistant packaging materials, more particularly, the preparation and use of lignin-based, formaldehyde-free. PFAS-free resins as coatings for paper packaging and paper products, and the resulting paper, paper packaging, and paper products. The present invention relates to oil-resistant packaging materials.

### BACKGROUND

Single-use tableware and food packaging are gaining popularity due to their convenience and sanitary benefits. They are suitable for various applications, including takeout and delivery orders, catering events, special occasions, and regular daily use. Paper-based products are more advantageous than other materials used for these items due to their cheaper cost and, more importantly, their compliance with sustainability goals and biodegradable properties.

However, unlike plastic ones, paper-based items suffer from significant disadvantages, such as a lack of oil resistance and water resistance. More specifically, paper-based and molded fiber single use tableware and food containers have inherently porous structures, which results in inadequate oil resistance. Oil resistance is essential for maintaining the integrity of the item and prevents leaks or stains from food, which is crucial for foods like burgers, fries, or fried chicken. To address the lack of oil resistance, paper-based products are often made by adding per- and polyfluoroalkyl substances (PFAS) to their raw materials during manufacture. Per- and polyfluoroalkyl substances are a group of synthetic organofluorine chemical compounds that have multiple fluorine atoms attached to an alkyl chain, which have been used in consumer products since the 1950s. Because the carbon-fluorine bond is one of the strongest, these chemicals do not degrade easily in the environment. Hence, these chemicals persist in the environment indefinitely and can hinder the biodegradation of paper-based items when used in high amounts. Additionally, PFAS can accumulate in the human body, leading to numerous health issues, including reproductive and developmental problems, immunological suppression, and tumor growth. Due to these risks, there is a growing demand for replacing PFAS with safe and environmentally friendly alternatives.

Some products use plastic coatings to overcome the above noted issues, but this adds an extra burden on the environment since the plastic layer is non-biodegradable and non-recyclable when attached to paper. There are global sustainability initiatives and consumer demand for environmentally friendly alternatives to plastics. Other alternative solutions for barriers on paper products, such as polyethylene coatings or wax layers, have been proposed, but these materials hinder biodegradability and recyclability as well.

Lignin, the second most abundant polymer after cellulose, represents a promising solution. Lignin is mainly produced as a side product in the pulp and paper industry. Conventionally, it is generally considered a low-value waste and is mainly burned to provide internal energy to power the paper mill. Lignin contains phenolic structures that can mimic the behavior of phenol in resins. Traditional phenol-formaldehyde resins are widely used in adhesives and coatings, but they suffer from toxicity concerns due to the use of formaldehyde.

Due to its low cost and eco-friendliness, lignin has recently attracted significant research interest as an alternative to oil-based chemicals. It has been investigated for its potential to provide paper with oil and water resistance properties; however, none of these approaches have been scaled up due to their low performance or costly and complicated methods of modification and implementation. Invented by Dr. Baekeland in 1909, the phenol-formaldehyde resin is a polycondensation thermoset resin made from phenol and formaldehyde by acid catalysis (novolac resin formation) or alkali catalysis (resole resin formation). It is widely used in plastics, coatings, and adhesives due to its low cost and raw material availability. However, phenol-formaldehyde resins are unsafe for humans because of the formaldehyde. Lignin, with its phenol-like aromatic chemical structure, has been a significant topic of interest as a safe, eco-friendly, low-cost, and bio-based alternative to phenol.

Hence, there is an urgent need to find new safe, sustainable, and cost-effective alternatives to PFAS. There is a clear market demand for PFAS-free, recyclable, and even biodegradable coatings capable of providing robust oil and moisture resistance to a paper product.

### SUMMARY

Lignin was tested herein as a safe, new, eco-friendly starting material for reaction with an aldehyde that is free or substantially free of formaldehyde to synthesize a food-safe, cost-effective, and bio-based resin, more particularly a resole resin that is coatable or castable onto a substrate. In a first aspect, lignin-based resole resins, in a second aspect, said resins create an oil-resistant layer on paper surfaces, and, in a third aspect, simplified and cost-effective methods to implement lignin as a safe, environmentally friendly raw material in preparing oil-resistant papers are disclosed herein

The first aspect is a resole resin composition that is a reaction product of a lignin, an aldehyde, and a strong base, wherein said composition is free of formaldehyde and is free of per- and poly-fluoroalkyl substances. The aldehyde is one or more of a straight or branched chain dialdehyde, a phenolic aldehyde, and a furanic aldehyde. In some embodiments, the aldehyde is selected from the group consisting of glyoxal, acetaldehyde, vanillin, cinnamaldehyde, furfural, salicylaldehyde, 3-hydroxy benzaldehyde, 4-hydroxybenzaldehyde, benzaldehyde, and combinations thereof.

In all embodiments, the lignin is one or more of a kraft lignin, an alkali lignin, an organosolv lignin, a hydrolyzed lignin, and a liquefied lignin. The reaction product can be in a solvent and can be a reaction product of lignin, an aldehyde, a strong base, and urea. The resole resin can be formed in an excess of aldehyde and strong base. The strong base comprises one or more of sodium hydroxide, potassium hydroxide, calcium hydroxide, and combinations thereof.

In all embodiments, the resulting resole resin has chromophoric groups that absorb visible light, has a pH of about 9 to about 13, a density of about 1.1 g/ml to about 1.5 g/ml, and a solids content of about 10% to 80%.

In the second aspect, a coated paper substrate has a paper layer, and a resole resin layer applied to a first surface of the paper layer. The resole resin is the resin composition described above and in the detailed description. The resole resin layer has a thickness greater than 30 μm, and more preferably greater than 35 μm, greater than 40 μm, greater than 45 μm, greater than 50 μm. In some embodiments, the thickness of the resole resin layer is in a range of 60 μm to 5 mils, more preferably in a range of 60 μm to 240 μm. In all embodiment, the resin layer on the paper substrate can resist penetration of hot oil at 65° C. for at least 25 minutes.

The paper substrate may be packaging material for a food product or packaging material for a cosmetic composition. In another embodiment, the substrate is a packaging material for a consumer good, such as a vegetable oil, butter, or other food products. In a further embodiment, the substrate is a building material, such as insulation fibers or insulation foam.

In the third aspect, methods of producing an oil-resistant paper article are disclosed that include applying the resole resin described above and in the detailed description to a paper substrate, drying the coated paper, and pressing the coated paper at a temperature in a range of 100° C. to 220° C. for a duration in a range of 10 seconds to 4 minutes. The drying and the pressing can occur simultaneously, the drying can occur before the pressing, or the pressing can occur before the drying. The method may include forming the paper substrate into a food packaging article or a tableware item, which can occur before or after applying the resole resin to the paper substrate.

The resins may be applied to paper substrates via casting, spraying, or roll coating, followed by air drying, oven drying, controlled environmental drying, and/or hot pressing. The resulting coated papers exhibit high oil resistance, with kit numbers of 10 to 12 under TAPPI standards and resistance to hot oil penetration for at least 25 to 40 minutes, depending on coating thickness.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flow chart of a method of making a lignin-based, formaldehyde free resole resin.

FIG. 2 is a flow chart of a method of making a paper product having a lignin-based, formaldehyde free resole resin thereon as an oil-resistant coating.

FIG. 3 is a Table of the effect of thickness on grammage and appearance, and oil-resistant performance including photographs of each sample.

FIG. 4 is an illustration of the evaluation set up for an oil penetration test.

FIG. 5 comprises FT-IR spectrum of Kraft lignin starting material compared to those of coated paper thicknesses.

FIG. 6 is a Table of Pressing Time and Temperature Affects related to coating thickness.

FIG. 7 is a chart of SEM images of the surface and cross-section views of folder papers with different thicknesses of lignin-based resole resin applied thereto.

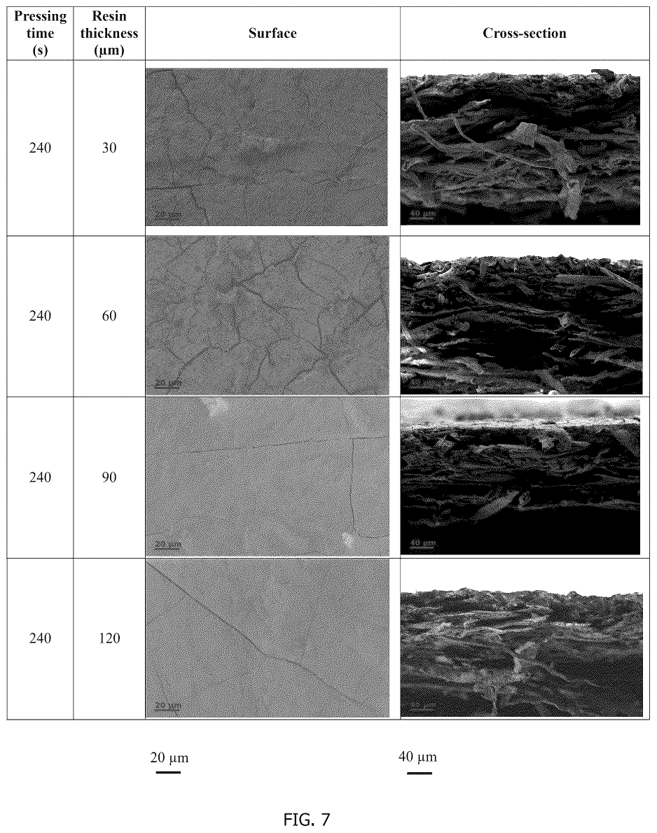

FIG. 8 presents stress-strain curves of prepared coated papers with different thicknesses of lignin-based resole resin.

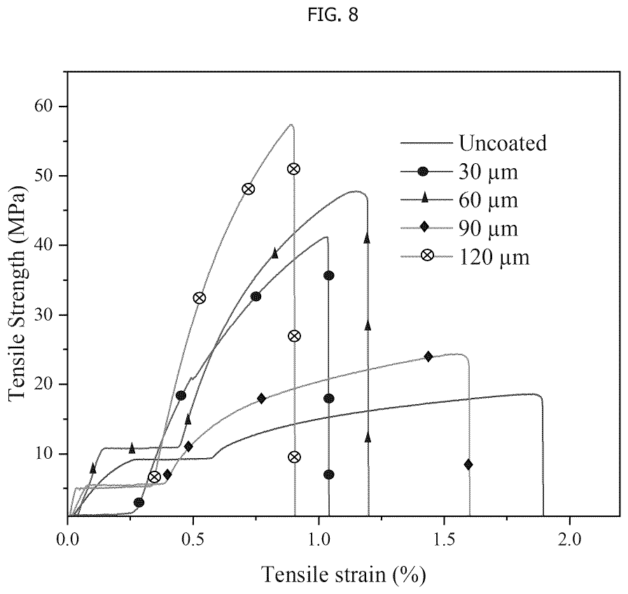

FIG. 9 is a chart of SEM images of the surface and cross-section views of folder papers with different thickness of lignin-based resole resin applied thereto after pressing.

### DETAILED DESCRIPTION

The following detailed description will illustrate the general principles of the invention, including the reaction mechanisms and flowcharts in the accompanying drawings. The materials, compounds, compositions, articles, and methods described herein may be understood more readily by reference to the following detailed description and the Examples included therein.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

All percentages, ratios and proportions herein are by weight, unless otherwise specified. All temperatures are in degrees Celsius (° C.) unless otherwise specified. The terms “a” and “an” are defined as one or more unless this disclosure explicitly requires otherwise.

Ranges may be expressed herein as from “about” one value, and/or to “about” another value, which includes values that are +/−1 increment of the stated unit, for example 8 mM includes 7 mM to 9 mM. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The feature or features of one embodiment may be applied to other embodiments, even though not described or illustrated, unless expressly prohibited by this disclosure or the nature of the embodiments. Unless defined otherwise, all technical and scientific terms used herein have the same meaning as commonly understood by a person of ordinary skill in the art to which this invention belongs. Although any methods and materials similar or equivalent to those described herein can also be used in the practice or testing of the described invention, the preferred methods and materials are now described.

Oil-resistant papers using a lignin-based resin were synthesized. The lignin-based resin, in one embodiment, was made using Kraft lignin as a starting material. The paper substrate may be selected from conventional packaging or printing papers, including kraft paper, card stock, or coated paperboard. The substrate can be cellulosic paperboard having a basis weight of about 150 g/m² to 350 g/m² and a thickness of about 0.25 mm to 0.60 mm. A lighter weight folder paper or card stock may be used, typically having a basis weight of about 80 g/m² to 150 g/m² and a thickness of about 0.10 mm to 0.25 mm. The substrate may be uncoated or pre-sized, and may exhibit a smooth or lightly textured surface to enhance adhesion of the resin coating. Suitable substrates can be recycled kraft paper, bleached or unbleached card stock, or fiberboard commonly employed in food packaging, paperboard containers, or folding cartons. The paper substrate was coated with different thicknesses (30, 60, 90, and 120 μm) of the prepared lignin-based resin. Each was dried in air and then pressed at various temperatures (140, 160, and 180° C.) for different durations (15, 30, 60, 120, and 240 s). The results indicated that regardless of pressing time and temperature, coating paper with a suitable amount of lignin-based resin can effectively block oil and meet the industry's requirements as a food packaging material, a food receiving surface (such as paper plates and paper cups), and/or a molded pulp articles. When 120 μm of the prepared lignin-based resin was used, the coated paper can block hot oil (65° C.) for more than 40 minutes for a kit number up to 12.

A lignin-based resin is synthesized under alkaline conditions in the presence of an aldehyde, i.e., a resole resin is the reaction product of a lignin, an aldehyde, and a strong base. The resole resin is free of formaldehyde and is free of per- and poly-fluoroalkyl substances. The aldehyde is one or more of a straight or branched chain dialdehyde, a phenolic aldehyde, and a furanic aldehyde. In some embodiments, the aldehyde is selected from the group consisting of glyoxal, acetaldehyde, vanillin, cinnamaldehyde, furfural, salicylaldehyde, 3-hydroxy benzaldehyde, 4-hydroxybenzaldehyde, benzaldehyde, and combinations thereof. The resins may be applied to paper substrates via casting, spraying, or roll coating, followed by air drying and hot pressing. The resulting coated papers exhibit high oil resistance, with kit numbers of 10 to 12 under TAPPI standards and resistance to hot oil penetration for at least 25 to 40 minutes, depending on coating thickness.

The resole resin composition comprises a reaction product formed from specific components under controlled conditions. The lignin utilized in the composition may be derived from various pulping processes and is typically considered a by-product thereof. Kraft lignin may serve as a primary source material due to its wide availability, low cost from popular Kraft pulping process, and low purity. Other lignin, such as lignosulfonates, organosolv lignin (OSL), soda lignin (also referred to as an alkali lignin), hydrolyzed lignin, and liquified lignin may alternatively be employed as the lignin by-product. In all embodiments, the lignin can be from pulp liquors from plant-based biomasses containing lignin, which can be used without the need to precipitate and purify the lignin. The lignin component may provide the phenolic backbone structure for the resole resin formation.

In one embodiment, the aldehyde is glyoxal. The glyoxal reacts with the phenolic groups present in the lignin structure. The reaction may occur under alkaline conditions. The strong base component may create the necessary alkaline environment for resin formation. Sodium hydroxide may be selected as the strong base. Potassium hydroxide may alternatively be used. Calcium hydroxide may serve as another option for the strong base component. Combinations of these strong bases may be employed depending on the desired resin properties.

The resole resin composition may be formulated to be free of formaldehyde. The absence of formaldehyde may provide environmental and health benefits. The composition may also be free of per- and poly-fluoroalkyl substances. Free of as used herein means that no formaldehyde was present in the reaction mixture and likewise no per- and poly-fluoroalkyl substances are present. In other embodiments, the resole resin may be substantially free of formaldehyde and substantially fee of per- and poly-fluoroalkyl substances. Substantially free as used herein means no more than 0.5%, more preferably no more than 0.01% of either substance individually is present in the resole resin, or even compliance with ISO 16000 standards of no more than 0.75 ppm air born volatile organic compounds from said packaging or compliance with EN 16576:2018 Volatile organic compounds (VOCs) emissions from food contact materials. This formulation may address concerns regarding persistent organic pollutants.

Any one or more of ethanol, isopropyl alcohol, propyl alcohol, n-butanol, and t-butanol may be incorporated as a solvent in the resin composition. The solvent may facilitate the mixing and reaction of the components. The solvent may improve the processability of the resin during application.

Urea may be added as a crosslinking stabilizer. The urea may enhance the crosslink density of the final resin structure. The crosslinking stabilizer may improve the mechanical properties of the cured resin.

The resole resin may be formed in an excess of aldehdye and strong base. The excess reactants may ensure complete reaction of the lignin component. The stoichiometric excess may drive the reaction toward completion. At molar ratios greater than 1.0 of aldehyde to phenolic component, the condensation reaction yields a resole-type resin that is self-curing under heat and capable of forming a thermoset network without the need for an external curing agent. The optimal aldehyde-to-phenol molar ratio is in the range of about 1.5 to about 2.5 moles of formaldehyde per mole of phenol, which provides a sufficient number of methylol groups to promote extensive crosslinking and the formation of a continuous polymeric network during the curing stage.

The characteristics of the resole resin include pH, density, solid content, and being chromophoric. The resin may comprise chromophoric groups that absorb visible light. These groups may impart color to the final resin composition. The chromophoric nature may result from the lignin structure and the crosslinking reactions. The resole resin composition may exhibit a pH in a range of about 9 to about 13. The pH in the examples herein was about 11. The alkaline pH may reflect the presence of the strong base component. The density of the resin may be in a range of 1.1 g/ml to about 1.5 g/ml. In the examples herein the density of the resin was about 1.3 g/ml. The density may vary depending on the specific formulation and processing conditions. The solids content of the composition may range from about 10% to about 80%, preferably about 30% to about 70%, and more preferably about 40% to about 60%. A secondary range of about 20% to 55% may be used for certain applications. A tertiary range of about 30% to 55% may be used for other applications.

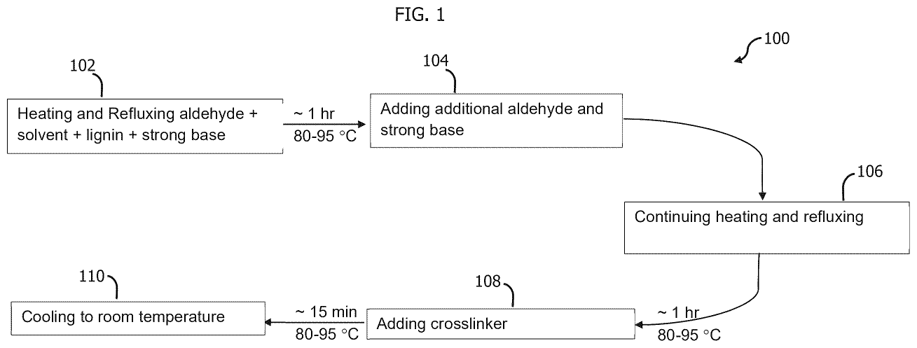

Referring to FIG. 1, the method of preparing the resin may follow a specific process sequence 100. The initial step 102 may involve heating and refluxing aldehyde with solvent, lignin, and strong base. The heating may be conducted at temperatures between 80° C. and 90° C. The refluxing may continue for approximately one hour. The kraft lignin may be mixed with glyoxal under these alkaline conditions. The heating may occur before or while the mixing takes place.

Step 104 may involve adding additional aldehyde and strong base to the reaction mixture. The additional components may enhance the crosslinking reaction. Step 106 may continue the heating and refluxing process. The continued heating may ensure complete reaction of all components. Step 108 may involve adding a crosslinker to the mixture. The crosslinker addition may occur for approximately one hour at 80-95° C. Urea may be added during this step to improve resin crosslink density. Step 110 may involve cooling the reaction mixture to room temperature. The cooling may occur after approximately 15 minutes at the elevated temperature.

The method may further comprise mixing a solvent with the kraft lignin and glyoxal. The solvent may be added before the heating step. The reaction mixture may be refluxed to maintain the reaction temperature. The resulting resin may be isolated after the cooling step. The isolation may involve separation from the reaction solvent and unreacted components.

The coated paper substrate may comprise a paper layer and a resole resin layer. The resole resin layer may be applied to a first surface of the paper layer. The resin composition may be the same as described in the previous embodiments. The resole resin layer may have a thickness greater than 30 μm. The thickness may be selected to provide adequate oil resistance properties.

The resole resin layer may have a thickness of about 60 μm to about 240 μm. A more preferred range may be about 60 μm to about 120 μm. The thickness may be controlled during the application process. The resin layer may resist penetration of hot oil at 65° C. for at least 25 minutes. The oil resistance may increase with greater coating thickness. The resin layer may achieve a TAPPI kit number of at least 10. Higher kit numbers may indicate superior oil resistance performance.

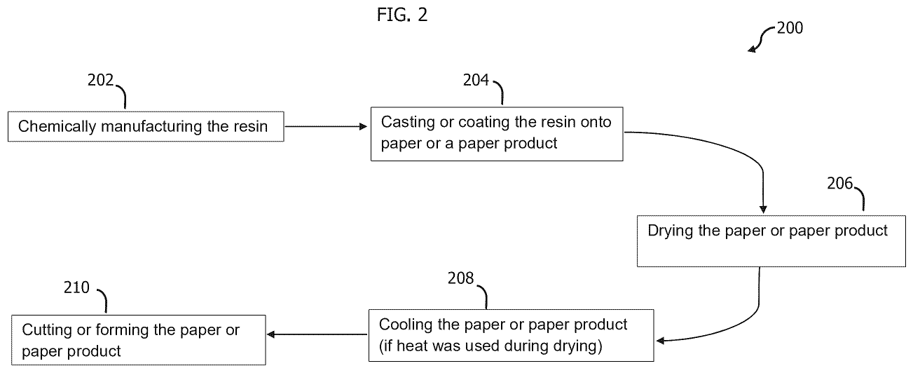

Referring to FIG. 2, the method of producing an oil-resistant paper article may follow process sequence 200. Step 202 may involve chemically manufacturing the resin according to the previously described methods. Step 204 may comprise applying the resole resin to a paper substrate. The application may be performed by casting or coating the resin onto the paper or paper product. The resin may be applied using various techniques including spraying or roll coating.

Step 206 may involve drying the coated paper. The drying may remove solvent and moisture from the applied resin layer. Step 208 may involve cooling the paper or paper product if heat was used during drying. The cooling may allow the resin to solidify and cure. Step 210 may involve cutting or forming the paper or paper product into the desired shape. The forming may create food packaging articles or tableware items.

The method may further comprise pressing the coated paper at temperatures between 140° C. and 180° C. The pressing may be conducted for between 15 seconds and 4 minutes. The pressing temperature and time may affect the final properties of the oil-resistant coating. The drying and pressing may occur simultaneously. Alternatively, the drying may occur before the pressing. In some embodiments, the pressing may occur before the drying.

The paper substrate may be formed before or after applying the resole resin. The forming may create food packaging articles such as containers or wrapping materials. The forming may alternatively create tableware items such as plates or cups. The final product may exhibit superior oil resistance compared to uncoated paper substrates.

Softwood kraft lignin was utilized as the primary phenolic feedstock in the examples disclosed herein. Any lignin produced as a byproduct of the pulping process is suitable herein, such as the kraft pulping process, the organosolv pulping process, or the soda pulping process, as well as those produced by any other process, such as hydrolyzation and/or liquification. Lignin sources include softwood, hardwood, corn stalk, sugarcane, straw, and any biomass containing lignin.

Lignin is a natural, aromatic polymer in plants that is produced in large quantities as a low-value byproduct of paper, pulp, and biorefinery industries. Despite its abundance and low cost, lignin remains underutilized and is often burned on-site to generate heat and energy in pulp mills. It is readily available and its use in resole resin coatings would solve two problems simultaneously, managing the lignin waste by-product from paper pulping and the need for an oil-resistant coating for paper products.

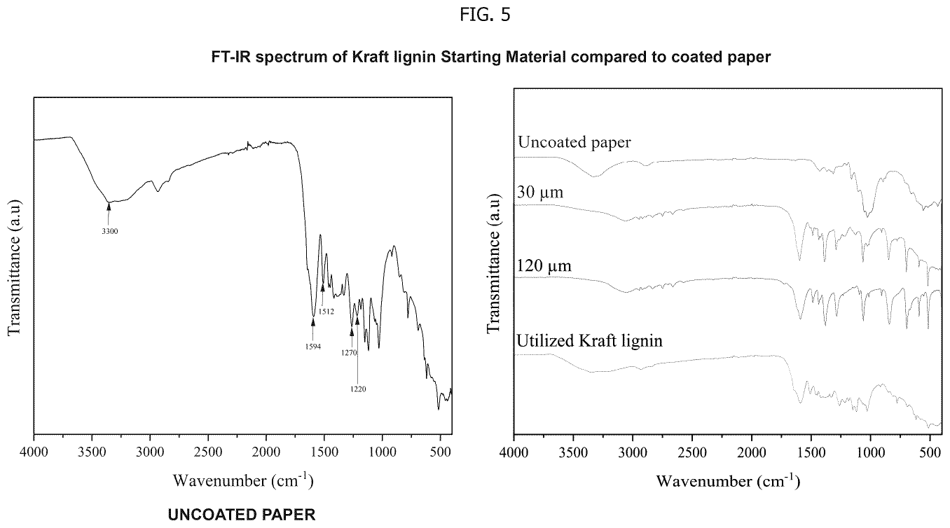

Referring to FIG. 5, the FT-IR spectrum of Kraft lignin reveals a complex structure with various functional groups. The broad peak around 3400 cm⁻¹ is characteristic of O—H stretching vibrations from phenolic and aliphatic hydroxyl groups present in lignin. Peaks at the range of 2800-3000 cm⁻¹ indicate the presence of aliphatic and aromatic C—H stretching vibrations, which are typically associated with methoxyl (—OCH₃) and methyl (—CH₃) groups in the lignin macromolecule. Characteristic lignin peaks also appeared at 1594 and 1512 cm⁻¹, corresponding to lignin's aromatic skeletal vibrations. Indicative peaks of guaiacyl and syringyl units have appeared at 1270 cm⁻¹ and 1220 cm⁻¹, respectively (Pourbaba et al., 2024; Wysokowski et al., 2014; Veiga et al., 2017). Guaiacyl is the dominant precursor in lignin extracted from softwood and results in a more substantial peak than syringyl. Peaks in the 1000-1200 cm⁻¹ region correspond to C—O stretching vibrations from the ether (—C—O—C—) and ester (—COO—) linkages. Peaks in this lower frequency range 600-900 cm⁻¹ correspond to out-of-plane bending vibrations of aromatic C—H bonds, which further confirm the presence of aromatic rings in lignin (Pourbaba et al., 2024).

The molecular weights of kraft lignin were determined through GPC analysis (after acetylation) and the result is shown in Table 1. The kraft lignin have a M̅ₙ (number-average molecular weight) in the range of 1,000-2,000 and a M̅_{w} in the range of 5,000-6,000, which are consistent with previously reported values. The molar-mass dispersity (Ð_{M}) is defined as the ratio of the M̅_{w} (weight-average molecular weight) to the M̅ₙ (number-average molecular weight). Kraft lignin from southern pine isolated via the LignoBoost process (Domtar Co. SC, USA) was served as the lignin reference for both GPC and 31P NMR analyses. The lignin was derivatized by dissolving ˜3 mg of lignin in a 1:1 v/v mixture of anhydrous pyridine and acetic anhydride and keeping the reaction at room temperature in dark with continuous magnetic stirring for 24 hours. Pyridine and remaining acetic anhydride were removed by co-evaporation with ethanol at 45° C.; this process was carried out several times using a rotary evaporator. Subsequently, the acetylated lignin samples were dissolved in tetrahydrofuran and filtered through a 0.45 μm membrane filter before being analyzed using GPC analysis. Size-exclusion separation was carried out by using a TOSOH HLC-8320GPC EcoSEC system (Tosoh Corp., Tokyo, Japan) with a refractive index (RI) detector and a TSKgel SuperAWM-H column. Tetrahydrofuran was used as the mobile phase, with a flow rate of 0.35 mL/min. The calibration curve was established using polystyrene standards.

TABLE 1
Molecular weights and dispersity of kraft lignin

| | M̅ₙ | M̅_{w} | Ð_{M} |
|---|---|---|---|
| Kraft Lignin | 1777 ± 12 | 6261 ± 165 | 8.1 |
| Lignin. Ref | 1524 ± 44 | 4031 ± 41 | 2.6 |

Values are presented as mean +/− standard deviation (n = 3).

The concentration of different hydroxyl groups in the kraft lignin were evaluated using 31P NMR spectroscopy and were compared to previously reported findings (“KL ref”) in Table 2 below. A Varian 400 MHz spectrometer was used to quantify the hydroxyl group contents in Kraft lignin sample by ³¹P NMR technique. Dried lignin samples (˜20 mg) were accurately measured and phosphitylated with 2-chloro-4,4,5,5-tetramethyl-1,3,2-dioxaphospholane (TMDP) in an anhydrous solvent mixture of pyridine/CDCl₃ (1.6:1.0 v/v), and n-hydroxy-5-norbornene-2,3-dicarboximide (NHND) was added as an internal standard according to the literature (Li et al., 2021). After adding TMDP, the ³¹P NMR spectra was obtained quickly (within <10 min). Numerous hydroxyl groups were clearly detected and distinguished in the spectra, including aliphatic OH (152.5-151.5 ppm), C₅ substituted (144.5-140.6 ppm), guaiacyl (140.2-138.8 ppm), other hydroxyphenyl group (138.3-137.3 ppm) and carboxylic hydroxyl groups (136.0-133.6 ppm). All chemical shifts were reported using the reference peak at 132.2 ppm, which was the result of the TMDP reaction with water.

Hydroxyl group contents were measured by adding an NHND internal standard in a specific amount. The NMR spectra was obtained using a Bruker Avance III HD 500-MHz spectrometer that has a N2-cryo-platform prodigy probe (BBO 1H and 19F-5 mm) attached to it. The amounts of hydroxyl groups in lignin were determined using quantitative 31P NMR, following the methods described in the literature (Li et al., 2021; Meng et al., 2019). In summary, dried lignin was treated with TMDP to undergo phosphitylation in a solvent mixture of pyridine/CDCl₃ (1.6:1.0 v/v), with the addition of NHND as an internal standard. The collection of ³¹P NMR spectra was performed promptly (<10 min) following the injection of TMDP. The spectra were acquired by the Waltz-16 inverse-gated decoupling pulse sequence. The pulse sequence involved a 90° pulse and a pulse delay of 25 s with 64 scans. The chemical shifts were reported using the product of TMDP with water at a concentration of 132.2 ppm as reference. The quantification of hydroxyl groups was determined by measuring the quantity of the NHND internal standard that was added.

TABLE 2

| Types of OH (mmol/g) | Kraft lignin | KL. REF |
|---|---|---|
| Aliphatic | 2.20 ± 0.36 | 2.02 ± 0.03 |
| C₅ substituted | 1.74 ± 0.23 | 1.89 ± 0.10 |
| Guaiacyl | 1.78 ± 0.06 | 2.08 ± 0.21 |
| Other Ar—OH | 0.22 ± 0.00 | 0.25 ± 0.01 |
| Carboxylic | 0.42 ± 0.01 | 0.54 ± 0.08 |
| Total | 6.36 ± 0.66 | 6.78 ± 0.43 |

Values are presented as mean +/− standard deviation (n = 3).

Glyoxal, a biocompatible aldehyde that is non-toxic. Glyoxal is an organic compound with the chemical formula OCHCHO; more specifically, it is a dialdehyde shown below to have the general formula (I). Glyoxal is available from Sigma-Aldrich as a 40% solution thereof. It is the simplest dialdehyde and is recognized as a safe because of its lower volatility and favorable regulatory profile.

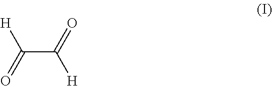

For comparison, the LD₅₀ for formaldehyde is in the range of 500-800 mg/kg, while glyoxal's LD₅₀ is considerably higher, ranging from 2960 to 8979 mg/kg, indicating its safety. Glyoxal also occurs naturally in various fermented foods and beverages, making it readily available.

Sodium hydroxide provides alkaline catalysis for the crosslinking reaction. Sodium hydroxide was purchased from Sigma-Aldrich and was utilized as provided. Ethanol may be used as a solvent to improve mixing, while urea can be added to stabilize the resin and improve its crosslinking density. Deionized water was used throughout as needed.

### Resole Resin Preparation

In one embodiment, 20 g of glyoxal solution and 10 g ethanol are combined in a three-neck flask. 30 g of kraft lignin is added and mixed, followed by 30 g of NaOH (40 wt %). The mixture is refluxed at 85° C. for 1 hour, to facilitate an alkaline condensation reaction. Additional NaOH and glyoxal are added dropwise, and the reaction is continued for another hour at 85° C. Urea may be added to enhance resin performance. In one embodiment, 10 g of NaOH and 20 g of glyoxal were added dropwise, and 3 g of urea was added and the reaction was maintained at the same conditions for 15 minutes. The resulting resin is a viscous black liquid that can be directly applied to paper substrates.

The lignin was a softwood kraft lignin supplied by WestRock Co. (East Dublin, Georgia, United States). It was obtained through a CO₂ precipitation method. It was a brown powder and utilized in its original form.

The solid content of each sample was measured using three replicates, following the guidelines outlined in ASTM D4426-01.36, the procedure being incorporated herein by reference. A summary of the process is as follows: 1 gram of the resin was measured and placed in an oven at 125° C. for 105 minutes. Subsequently, the samples were cooled to the ambient temperature in a desiccator and then measured for weight. The percentage of solid content was determined by dividing the weight of the resin after it was dried in an oven by the original weight of the resin and then multiplying the result by 100. A PH meter was employed to measure the pH of resins and adhesives at room temperature, such as a Fisher Science Education digital pH meter. The weight of a micropipette tip was measured using a 4-digit analytical balance before being utilized to collect 800 microliters of resin. The resin-filled tip was reweighed. The exterior of the pipette tip was meticulously cleansed to ensure that only the volume of resin contained within the tip was measured. The resin density was calculated by dividing the weight of resin inside the tip by the volume of collected resin (0.8 ml).

The lignin-based resin prepared was black, unlike traditional phenol-formaldehyde resins, which typically exhibit a reddish-brown color. This black color results from incorporating lignin, known for its complex aromatic structure and chromophoric groups that absorb visible light. The lignin-based resin's solid content is about 52% (52.110+/−1.94%), a pH of about 11 (11.03+/−0.14) and a density of about 1.3 (1.32+/−0.03). The experimental solid content agrees with the theoretical solid content (52.85%). This confirms that the glyoxal employed reacted with both the lignin and another component present in the resin rather than simply evaporating. The measured pH for the lignin-based resin is lower than the pH reported known formaldehyde resins. This is likely due to glyoxal's side reaction in an alkaline environment, which is more significant than formaldehyde, leading to the production of glycolic acid and subsequently decreasing the pH. The obtained density is higher than those known for formaldehyde resins, which is theorized to be a result of a higher solid content and the presence of urea in the reaction mechanism.

### Coating Tests

For testing purposes, the lignin-based resin was applied to paper substrates in thicknesses ranging from 30 μm to 120 μm using casting, roll coating, or knife coating. Knife coating is a widespread technique employed in the paper packaging industry to apply thin, uniform layers of functional materials—such as barrier polymers, adhesives, or pigments—onto continuous flat substrates like paper. This technique involves applying excessive coating material to the substrate surface, then using a blade (sometimes known as a “knife”) to gauge the coating and control its thickness by varying the distance between the blade and the substrate. The rheological properties of the coating formulation, particularly viscosity and flow behavior, play a significant role in achieving uniform coatings.

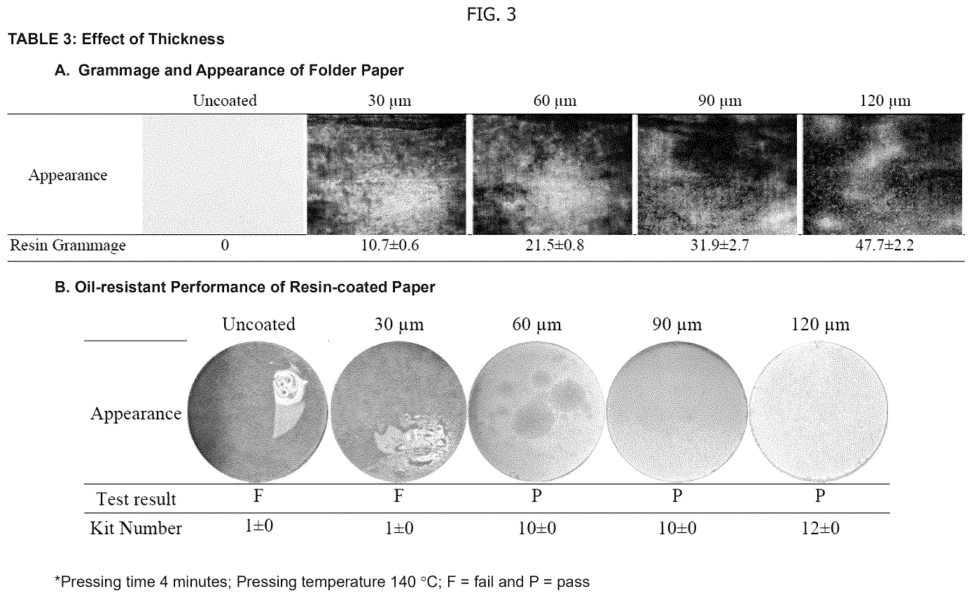

For the data presented in FIG. 3, the lignin-based resin was applied by casting using a 4-edge stainless steel applicator. The thickness applied and tested were 30 μm, 60 μm, 90 μm, and 120 μm. Following application, papers were dried at ambient temperature for 15 minutes and subjected to hot pressing at 140° C., 160° C., and 180° C. for durations between 15 seconds and 4 minutes, using times that doubled (15 s, 30 s, 60 s, 120 s, 240 s).

The basis weight or mass per square meter of the unmodified and modified papers was measured per the ASTM D646 protocol (18). The paper was cut into 12×12 cm² sections. In addition, the weight of the paper was recorded before and after coating. Equation 1 below was used to calculate the basis weight, where the weight is expressed in g, and the area is expressed in m². The resin grammage was calculated using equation 2 below and is expressed in g/m².

$$Basis weight = Weight ( g ) / Area ( {m}^{2} ) \qquad ( 1 )$$

$$Resin Grammage = Basis weight ( coated ) - Basis weight ( uncoated ) \qquad ( 2 )$$

Experimental results demonstrate that 60 μm to 120 μm resin coatings yield excellent oil resistance. A 120 μm coating resists penetration of hot soybean oil at 65° C. for more than 40 minutes, achieving kit numbers up to 12. Thinner coatings (30 μm) fail under the same conditions. Pressing times as low as 15 seconds at 140° C. achieve maximum performance, indicating compatibility with continuous industrial production. Increasing pressing temperatures does not significantly improve performance.

Folder papers were coated with varying thicknesses of the prepared resin, as described previously. The appearance of the coated paper surfaces after curing at thicknesses of 30 μm, 60 μm, 90 μm, and 120 μm is shown in FIG. 3, Table 3, Part A. The grammage per square meter increased about 10 g/m² between 30 μm and 60 μm and between 60 μm and 90 μm, but increased by almost 16 grams between 90 μm and 120 μm. There is a clear correlation between coating thickness and the color strength of coated paper: as thickness increases, the cured resin exhibits a darker color. This suggests that the increased thickness affects the final appearance of the coated paper. The relationship between thickness and resin appearance is significant for the overall properties and potential applications of the coated paper. Color significantly impacts consumer perception and purchasing decisions. In the context of food packaging, color can evoke specific emotions. A darker paper might be perceived differently than a lighter one, potentially influencing consumer acceptance. Grammage, or the weight of paper per unit area, is directly linked to production costs. A thicker coating (higher grammage) increases the price of the final product (and makes the product appear darker). Balancing resin grammage, cost, and desired paper properties is crucial. While a thicker coating might offer increased oil resistance, it can also increase brittleness. Additionally, grammage affects the paper's barrier properties against moisture and oxygen. Ultimately, the choice of coating thickness and color should be based on carefully considering consumer preferences, packaging requirements, and production costs.

### Oil Resistance Tests

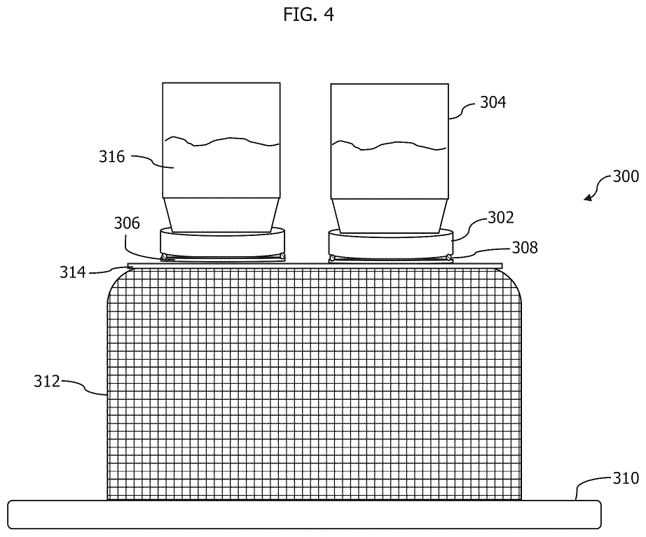

Referring to FIG. 4, plastic caps 302 of jars 304 were drilled to create a hole with a 3 cm radius. The jars 304 were cut open (i.e., a portion of the bottom thereof was removed) to define an easily refillable reservoir open to air. To evaluate the oil resistance of the coated papers 306, the papers 306 were cut into circular pieces and securely attached to the bottoms of these plastic caps 306, with the coated side facing inward, for example, using silicone sealant 308. The caps 302 were then screwed back onto the jars 304 and tightened. A mirror 310 was laid on the table, and a wire basket 312 (or rack) was positioned on top of the mirror 310. A piece of tissue paper 314 was placed on the wire basket 312. Soybean oil 316 was heated to 65° C., and the jars 304 were filled with the hot soybean oil. The jars 304, containing the hot soybean oil, were then placed on the tissue paper 314. This setup was designed to enable oil leaks or stain on the tissue paper to be visually monitored by looking at the mirror 310.

The oil resistance (or grease resistance) of the coated papers was evaluated using the TAPPI kit test (TAPPI T 559, the details of which are incorporated herein by reference) and the results were reported as “Kit numbers.” Commonly known as the “Kit test,” this method describes a procedure for testing the degree of repellency and/or the antiwicking characteristics of paper or paperboard treated with fluorochemical sizing agents. Fluorochemical agents may impart both organophobic and hydrophobic characteristics to paper through a reduction in the surface energy of the sheet. This is often done by a surface treatment of the fibers without the formation of continuous films. This test was originally developed to allow papermakers to know when the applied fluorochemical was incorporated into the sheet and the approximate level of grease resistance imparted. Testing involves placing a series of numbered reagents (varying in surface tension and viscosity or “aggressiveness”) onto the surface of the sample. The solutions are numbered from 1 (the least aggressive) to 12 (the most aggressive). The highest numbered solution that does not stain the surface is reported as the “kit rating.”

Solutions with different compositions of castor oil, toluene, and n-heptane were prepared according to the standard TAPPI T 559 test, ranging from 1 to 12 with the less aggressive represented as number 1 to the most aggressive represented as number 12. The samples were cut to dimensions of approximately 20×40 mm and placed on a flat, horizontal surface. Starting with Kit solution 1, one drop of the solution was placed on the center of the test specimen using a dropper. After 15 seconds, the excess solution was gently removed with a clean piece of tissue paper and the sample was examined for any signs of oil penetration or staining. If no stain was observed, the process was repeated with a fresh paper sample with the next higher kit number solution. The highest kit number in which the paper shows no penetration or stain is considered as the “Kit number” for the sample. The test was repeated three times for each sample and the average results were reported. The kit numbers determined by this process are included in FIG. 3, Table 3, Part B.

The oil resistance of the coated papers was evaluated with varying thicknesses (30 μm, 60 μm, 90 μm, and 120 μm) of the lignin-based resin applied thereto. According to industry standards, coated paper is considered oil-resistant if it exhibits no staining on the underside of the tissue after 20-25 minutes of contact with hot oil (65° C.). Our results indicate that all coated papers except the 30-μm thickness passed this hot oil resistance test. Kit number results are presented in Table 3, and they further support these findings. A 120 μm coating achieved the maximum oil resistance (kit number 12), while 60 and 90 μm coatings produced acceptable oil resistance for many paper products (i.e., a kit number 10). To visualize the oil resistance, photographs of the back side of the papers after 25 minutes are shown in Table 3. While the bare folder paper and the 30-μm coated paper exhibited visible signs of oil penetration, the 90 μm and 120 μm coated papers remained dry without staining. Interestingly, the 60 μm coated paper showed minimal staining but still passed the test due to insufficient oil penetration to cause visible staining on the underlying tissue. A thicker coating creates a longer and more tortuous path for oil to permeate through, hindering its ability to reach the back side of the paper. However, it is essential to consider the trade-off between oil resistance and other critical factors such as cost and functionality. Thicker coatings generally translate to higher production costs due to increased material usage. Additionally, excessively thick coatings may negatively impact the final paper product's flexibility, printability, or other properties.

Another applicable test for oil resistance is ISO 16532-1:2008, which assesses the time it takes for a simulated fat substance (palm kern oil) to permeate paper or board and then calculates a grease resistance value related thereto. This test applies to papers and boards that have been internally, or surface sized with organophilic substances or rendered grease-resistant through plastic extrusion coating (I S O. 2008. Paper and board—Determination of grease resistance Part 1: Permeability test. https://www.iso.org/standard/37980.html).

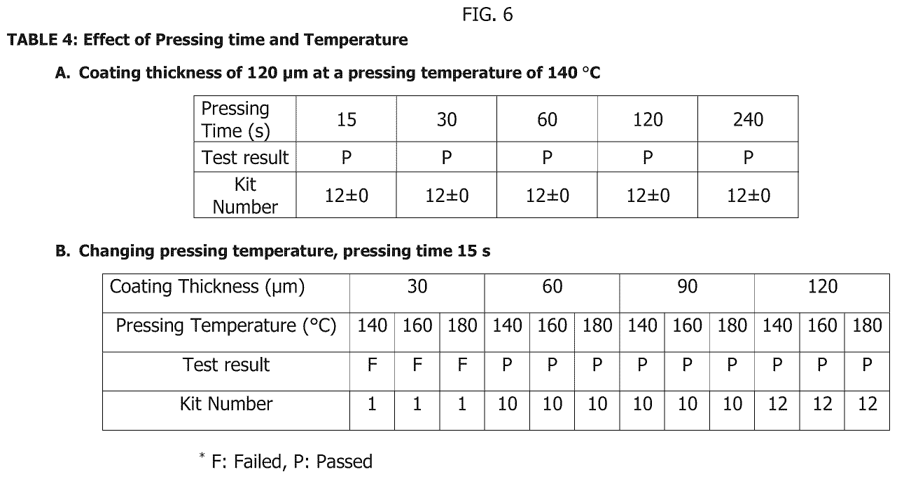

To examine the surface texture of the samples, Scanning Electron Microscopy (SEM) pictures were captured using a JEOL 6610 SEM (JEOL Ltd., Japan) system with an accelerating voltage of 15 kV. Samples were mounted onto aluminum stubs using carbon double-sided tape to prepare them for SEM analysis. A sputtering coating machine was then used to apply a 15 mm thick layer of gold on the samples. The materials were broken up in liquid nitrogen prior to coating to get the cross-section pictures. The SEM images in FIG. 6 illustrate the surface and cross-sectional morphology of paper substrates coated with lignin-based resole resin at varying thicknesses of 30 μm, 60 μm, 90 μm, and 120 μm. The surface morphology reveals noticeable differences in crack formation and coating uniformity across different thickness levels. At 30 μm and 60 μm, significant mud cracks are observed, likely resulting from drying stress and shrinkage during water evaporation.

During the drying process of water-based paper coatings, capillary forces play a significant role in shrinkage. As water evaporates, it recedes through the porous structure of the coating, generating capillary pressure that leads to shrinkage. This shrinkage can induce drying stress(es) within the coating layer, potentially resulting in crack formation. These cracks suggest potential brittleness in the coating, which may affect its barrier properties. As the coating thickness increases to 90 μm and 120 μm, the surface appears smoother with fewer cracks, indicating improved stress distribution. However, some large cracks remain visible, suggesting that increased thickness can mitigate surface cracking. The overall trend indicates that a thicker resin layer may enhance coating uniformity while reducing crack density, which is crucial for applications requiring high-performance barrier properties.

The cross-sectional SEM images further highlight the effect of coating thickness on the interaction between the lignin-based resole resin and the paper substrate. At lower thickness levels (30 μm and 60 μm), the resin layer appears relatively thin and conforms closely to the fibrous paper network, allowing for noticeable penetration into the structure. This penetration enhances adhesion but may result in incomplete surface coverage, leaving some fibers exposed. In contrast, at 90 μm and 120 μm, the coating forms a more distinct and continuous layer over the substrate, providing better coverage and potentially improving mechanical stability. The 120-micron coating, in particular, appears to be the most uniform, though some regions exhibit resin accumulation and localized defects, likely due to uneven drying or internal stress.

The tensile properties of all coated papers were measured using a universal testing machine (Instron 5567) in accordance with the ASTM D828-22 standard. A 30 kN load cell was used with a gauge length of 60 mm and an extension speed of 5 mm/min. Tests were conducted at 25° C. and 50% relative humidity. Each test specimen had a length of 100 mm and an average width of 20 mm, with the thickness measured individually for each sample. An average of three repeated measurements per sample was taken.

The uncoated folder paper exhibited a tensile stress of 16.33±3.18 MPa and a modulus of 3108.36±224.42 MPa. After applying lignin-based resin coatings, a clear improvement in tensile properties was observed. At 30 μm and 60 μm, the tensile stress increased to 43.11±2.72 MPa and 45.60±2.21 MPa, respectively. This improvement can be attributed to the formation of a resin layer on the paper surface with limited penetration into the upper fiber network. By anchoring to the surface fibers, this layer reinforces the paper structure and results in a net enhancement of mechanical performance. Similar improvements in tensile strength and stiffness have been reported for polymer-coated papers, such as those treated with hydroxypropyl methylcellulose (HPMC). At 90 μm, however, an unexpected decrease in mechanical strength was observed. This reduction is likely caused by deeper resin penetration into the lower fiber layers, which disrupts natural fiber-to-fiber bonding and weakens the substrate. When the coating thickness was further increased to 120 μm, the mechanical strength not only recovered but reached its maximum value. Despite continued resin penetration, the formation of a thick, continuous surface layer acted as a load-bearing film, compensating for the loss of inter-fiber interactions in the paper. Overall, the recovery and further improvement in tensile strength and modulus at 120 μm suggest the existence of a threshold coating thickness, at which the reinforcing effect of the surface resin layer outweighs the drawbacks associated with resin penetration into the fiber network.

In all industries, the time spent producing a specific item is of utmost importance as it determines the total cost of production, profitability, and even the feasibility of manufacturing a product. Therefore, reducing the time required to produce an item is crucial for efficiency and economic viability. To investigate the effect of pressing time on the performance of coated paper, the impact of different pressing durations was examined.

Papers coated with 120 μm of resin were subjected to pressing times of 15 s, 30 s, 60 s, 120 s, and 240 s, and their performance was evaluated as before. The results are presented in FIG. 6, Table 4, Part A. As shown, all coated papers achieved a Kit number of 12 and successfully passed the oil resistance test. This indicates that even a pressing time of 15 seconds is sufficient to achieve maximum performance of the coated resin. The processing time is a critical parameter for determining whether a new technology or method can be scaled up and commercialized. In industrial applications, shorter processing times translate into higher production rates and lower operational costs. The finding that a pressing time of just 15 seconds is adequate for curing the resin and achieving optimal oil resistance suggests that this resin formulation is suitable for use in a continuous production line. Implementing a rapid pressing process can enhance production efficiency, making producing oil-resistant papers at a competitive cost feasible. This short pressing time simplifies industrial operations, minimizes energy usage, and increases throughput.

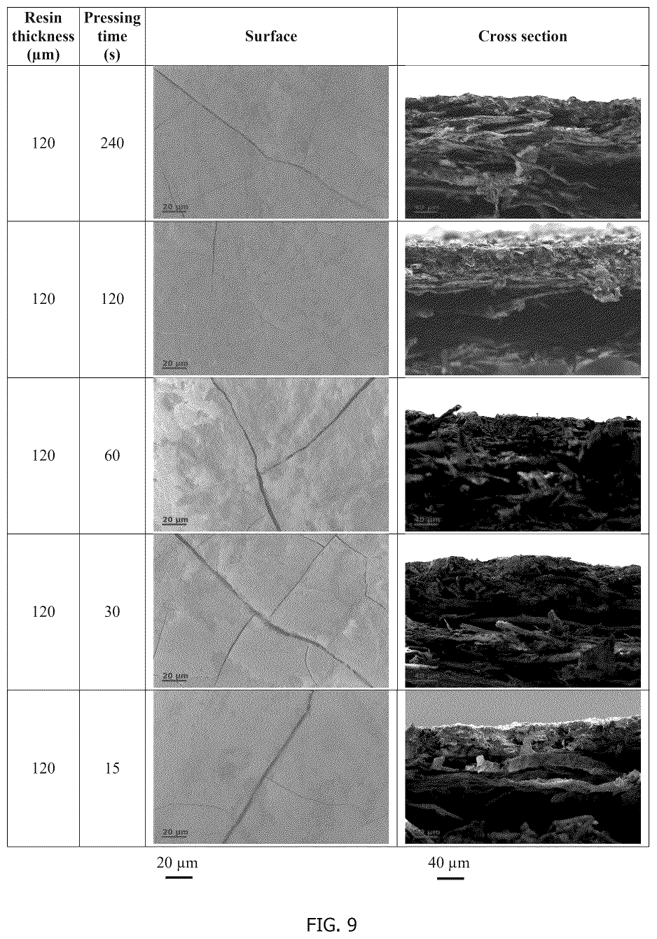

The effect of pressing time on the structure and morphology of the prepared coated papers was investigated using SEM images. Paper coated with 120 μm of resin was pressed for 15 s, 30 s, 60 s, 120 s, and 240 s at 140° C. The samples were then fractured in liquid nitrogen to examine the cross-sectional morphology, and SEM images were obtained, and the results are shown in FIG. 9. As observed, when the pressing time decreases from 240 s to 120 s, the apparent thickness of the resin layer increases, indicating a reduction in resin penetration into the paper substrate. However, further reducing the curing time below 120 s does not significantly affect the apparent thickness, suggesting that the resin reaches a limit in its ability to spread and adhere effectively under these conditions. Additionally, surface SEM images reveal that longer pressing times lead to a smoother and more uniform resin layer, likely due to enhanced flow and better integration with the paper fibers. In contrast, the resin layer appears less uniform and more textured at shorter pressing times, with visible surface irregularities and potential voids. These differences suggest that pressing time influences not only the resin thickness but also the surface smoothness, homogeneity, and adhesion to the paper substrate. However, as observed in the performance data, the oil resistance of the coated paper remains unaffected by pressing time, meaning that the same level of performance can be achieved regardless of whether the pressing duration is 15 s or 240 s. This finding has significant implications for potential scale-up and industrial adoption. If the required oil resistance can be achieved with just 15 s of pressing, this drastically reduces production time, allowing for faster throughput and increased manufacturing efficiency. Additionally, shorter pressing times translate to lower energy consumption, reducing the overall operational costs associated with heating and curing. By optimizing the process to maintain performance while minimizing pressing time, this approach presents a highly viable and cost-effective strategy for commercial-scale implementation.

As mentioned above, the thickness of the applied resin is a key parameter in determining the cost of the final product. To minimize the quantity of resin required to achieve maximum oil resistance, we investigated the effect of higher pressing temperatures on papers coated with thinner resin layers (30, 60, and 90 μm). Papers were coated with these resin thicknesses and pressed at 160° C. and 180° C. The performance of the prepared papers is presented in FIG. 6, Table 4, Part B. The results indicate that increasing the curing temperature does not enhance the performance of the resin-coated papers compared to those cured at 140° C. Specifically, pressing temperatures did not improve the oil resistance of papers coated with 30 μm of resin. These papers failed to pass the oil resistance test even when pressed at 180° C. This suggests that if the resin layer is too thin to block oil penetration, increasing the pressing temperature cannot compensate for this deficiency. Furthermore, the data show that the higher curing temperatures do not improve the Kit number of the produced papers with 60 and 90 μm of resin. This finding implies that the resin's effectiveness in providing oil resistance is primarily determined by its thickness rather than the curing temperature. Consequently, achieving the desired oil resistance performance requires maintaining an adequate resin thickness, regardless of the curing temperature.

The resulting paper or paper product is ideal for food delivery services and restaurants due to its oil resistance, enabling safe and hygienic food transportation. A couple examples of foods packaging include but are not limited to clamshell containers, burger wraps, French fry boxes, pizza liners, molded pulp bowls. Beyond the food business, this new paper offers great promise for packaging and shipping oils, offering a more sustainable alternative to existing materials, such as cosmetic packaging that need oil-resistant cartons, oil-resistant coating for shipping and storage of oily goods or products. Furthermore, lignin-based resole resins show potential in a variety of applications. Its usage as an adhesive for wood-based composites can improve the sustainability of construction materials by providing an environmentally friendly choice with robust bonding qualities. In the construction and automotive industries, resin can be utilized as insulation foam, improving thermal and acoustic insulation while lowering dependency on synthetic materials.

The lignin-based resole resin and the coated paper product utilizing the same provide myriad advantages. The starting materials are renewable material of natural origin, especially the lignin. Utilizing the lignin from the pulp industry (a waste by-product), means that no additional tree-cutting is required. The resin is formaldehyde free, PFAS free, and it may be biodegradable. This new application of lignin enhances the economic viability of pulp and paper companies and other biorefinery plants.

The synthesis process disclosed herein is straightforward and cost-effective, making it accessible for large-scale production. Using glyoxal as a substitute for formaldehyde addresses health concerns associated with formaldehyde in phenol-formaldehyde resins. The resulting resin can replace fossil-based materials across a wide range of applications, reducing significant emissions.

Although the invention is shown and described with respect to certain embodiments, modifications will occur to those skilled in the art upon reading and understanding the specification, and the present invention includes all such modifications.

1. A resole resin composition comprising:
a reaction product of a lignin, an aldehyde, and a strong base, wherein said composition is free of formaldehyde and is free of per- and poly-fluoroalkyl substances;
wherein the aldehyde is one or more of a straight or branched chain dialdehyde, a phenolic aldehyde, and a furanic aldehyde.

2. The resin composition of claim 1, wherein the aldehyde is selected from the group consisting of glyoxal, acetaldehyde, vanillin, cinnamaldehyde, furfural, salicylaldehyde, 3-hydroxy benzaldehyde, 4-hydroxybenzaldehyde, benzaldehyde, and combinations thereof.

3. The resin composition of claim 1, wherein the lignin is one or more of a kraft lignin, an alkali lignin, an organosolv lignin, a hydrolyzed lignin, and a liquefied lignin.

4. The resole resin composition of claim 1, wherein the reaction product is in a solvent.

5. The resole resin composition of claim 1, wherein the reaction product further comprises urea.

6. The resole resin composition of claim 1, wherein the resole resin is formed in an excess of aldehyde and strong base.

7. The resole resin composition of claim 1, wherein the strong base is selected from the group consisting of sodium hydroxide, potassium hydroxide, calcium hydroxide, and combinations thereof.

8. The resole resin composition of claim 1, wherein the resin comprises chromophoric groups that absorb visible light.

9. The resole resin composition of claim 1, wherein the resole resin has a pH of about 9 to about 13 and a density of about 1.1 g/ml to about 1.5 g/ml.

10. The resole resin composition of claim 1, wherein the resole resin comprises a solids content of about 10% to 80%.

11. A method of preparing a resin, comprising:
mixing a lignin with an aldehyde under alkaline conditions before or while heating to between 80° C. and 90° C.; and
isolating the resulting resin.

12. The method of claim 11, further comprising adding urea to improve resin crosslink density.

13. The method of claim 11, further comprising mixing a solvent with the lignin and aldehyde as a solvent and refluxing the reaction mixture.

14. A coated paper substrate comprising:
a paper layer; and
a resole resin layer applied to a first surface of the paper layer, wherein the resole resin is the resin composition of claim 1;
wherein the resole resin layer has a thickness greater than 60 μm.

15. The coated paper substrate of claim 13, wherein the resole resin layer has a thickness of about 60 μm to about 240 μm.

16. The coated paper substrate of claim 13, wherein the resole resin layer has a thickness of about 60 μm to about 120 μm.

17. The coated paper substrate of claim 13, wherein the resin layer resists penetration of hot oil at 65° C. for at least 25 minutes.

18. A method of producing an oil-resistant paper article, comprising:
applying the resole resin of claim 1 to a paper substrate;
drying the coated paper; and
pressing at a temperature in a range of 100° C. to 220° C. for a duration in a range of 10 seconds to 4 minutes.

19. The method of claim 18, wherein the drying and the pressing occurs simultaneously, the drying occurs before the pressing, or the pressing occurs before the drying.

20. The method of claim 18, further comprising forming the paper substrate before or after applying the resole resin into a food packaging article or a tableware item.
